(19) United States
(12) Patent Application Publication
(10) Pub. No.: US 2013/0103483 A1
(43) Pub. Date: Apr. 25, 2013

(54) Mobile Loyalty Management System

(71) Applicant: Youwei Xue, Portland, OR (US)

(72) Inventor: Youwei Xue, Portland, OR (US)

(21) Appl. No.: 13/656,646

(22) Filed: Oct. 19, 2012

Related U.S. Application Data
(60) Provisional application No. 61/548,897, filed on Oct. 19, 2011.

(51) Int. Cl. G06Q 30/02; G06Q 20/20

(52) U.S. Cl. 705/14.27

(57) ABSTRACT

In accordance with embodiments of the present disclosure, a process to sign-up a consumer with a loyalty program is provided. The process may include generating, by a first mobile device, a secured consumer ID for identifying the consumer; and receiving, by the first mobile device, a program ID associated with the loyalty program. The process may include transmitting, by the first mobile device, a request with the secured consumer ID and the program ID to a loyalty management system for signing up to the loyalty program, wherein the loyalty management system retrieves credential information associated with the consumer based on the secured consumer ID, and uses the credential information to automatically sign-up the consumer to the loyalty program identified by the program ID. The process may further include, upon successful signing-up to a membership of the loyalty program, receiving, by the first mobile device from the loyalty management system, a first merchant service provided by the loyalty program.

### CROSS REFERENCE

This application claims the priority of a U.S. Provisional Application No. 61/548,897, filed on Oct. 19, 2011, which is hereby incorporated by reference in its entireties, including any appendices or attachments thereof, for all purposes.

### BACKGROUND

Unless otherwise indicated herein, the approaches described in this section are not prior art to the claims in this application and are not admitted to be prior art by inclusion in this section.

Conventional loyalty program may require a consumer to first manually sign-up with a merchant's membership program. Afterward, the consumer may receive a physical membership card having a particular membership ID. When the consumer is ready to redeem membership benefits, he/she needs to present the membership card to the merchant. Upon verification of the membership card, the merchant may either offer membership discount, or provide certain privileged services to the consumer. In many situations, if the consumer cannot present the physical membership card, even though the consumer belongs to the membership program, he/she cannot receive the discount, or receive the privileged services.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 illustrates an example of a loyalty management system in an operational environment;

FIG. 2 illustrates exemplary interactions among multiple actors in a mobile loyalty management environment;

FIG. 3 illustrates multiple screen shots of a loyalty management client;

FIG. 4 shows a flow diagram illustrating one example process for signing-up and utilizing a loyalty program;

FIG. 5 shows a flow diagram illustrating one example process for providing automatic signing-up services by a loyalty management system and providing associated merchant services; and

FIG. 6 shows a flow diagram illustrating one example process for interacting with mobile devices by a point-of-sale system, all arranged in accordance to at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, computer programs, and systems related to a loyalty management system. Throughout the disclosure, the term “loyalty program” may broadly refer to a membership program that rewards members of the program (e.g., consumers or clients of a merchant) for their past loyalties, and/or attracts the current and potential consumers/clients to conduct additional businesses with the merchant. For example, a loyalty program may be an airline frequent-flier program that provides incentives to fliers who have purchases a certain amount of flights. A loyalty program may also be a VIP program which provides specific privileges to a person who is deemed a valuable client with a high economic and social status. Further, a loyalty program may be any program that provides incentive, discount, and/or convenient services to its members.

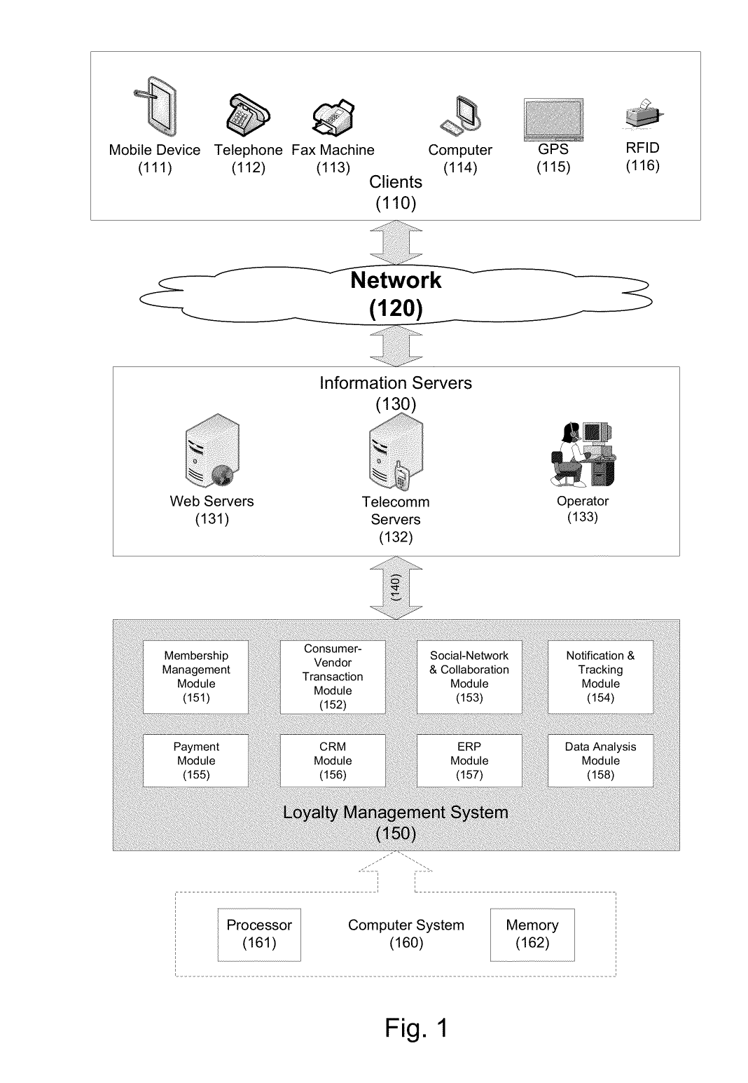

FIG. 1 illustrates an example of a loyalty management system in an operational environment, in accordance with at least some embodiments of the present disclosure. In FIG. 1, a loyalty management system (LM system) 150 contains multiple functional modules to perform loyalty program management activities. The LM system 150 may interact with external devices and systems via multiple information servers 130. The information servers 130 provide remote network communication services to a set of clients 110 through a network 120. The network 120 may be, for example, a local area network (LAN), wide area network (WAN), metropolitan area network (MAN), global area network such as the Internet, a Fibre Channel fabric, or any combination of such interconnects. The network 120 may also be a wireless network, such as, without limitation, mobile device network (GSM, CDMA, TDMA, and others), wireless local area network (WLAN), and wireless Metropolitan area network (WMAN). The clients 110 and the information servers 130 may interact among themselves via a set of communication channels provided by the network 120.

In one embodiment, a client 110 may be one of the computing devices that can communicate directly or indirectly with the LM system 150. The client device 110 may be a mobile device 111, a telephone 112, a fax machine 113, or a general or specific computer 114. The client device 110 may further be any computing device that is capable of communicating with other applications and/or devices in a network environment. In one embodiment, the mobile device 111 may be a mobile, handheld, and/or portable device, such as, without limitation, a Personal Digital Assistant (PDA), cell phone, smart-phone, GPS, video recorder, or MP3/MP4 player. The mobile device 111 may be used to make phone calls, send or receive text messages, and access Internet, etc. The telephone 112 may be any device that is primarily used for placing phone calls. Likewise, the fax machine 113 may be a device that is suitable for sending and receiving faxes. Further, the computer device 114 may be a conventional personal computer (PC), server-class computer, workstation, handheld computing or communication device, or the like. For example, the computer device 114 may be a point-of-sale system utilized by retailers.

In one embodiment, a set of information servers 130 may be connected to the network 120. The information servers 130 may be implemented by one or more web servers 131, one or more telecommunication servers 132, and/or one or more telecommunication systems managed by operators 133. In one embodiment, a web server 131 may transmit and receive web messages to/from any one of the client devices 111-114. A telecommunication server 132 may process voice or fax messages transmitted via a mobile device 111, a telephone 112, and/or a fax machine 113. Further, the telecommunication server 132 may send or receive text messages (SMS) during messaging communication with a mobile device 111 or a computer 114.

In one embodiment, the messages transmitted or received via the network 120 may be originated by human. In this case, the operator-managed telecommunication systems 133 may perform voice-recognition or manually input the human's requests into data messages, before transmitting the data messages to the LM system 150. For example, upon receiving a call from a consumer's mobile device 111 for using a membership program, an operator may input the consumer's detail requests into a telecommunication system 133, so that the requests may be properly transmitted to and processed by the LM system 150. Later, the LM system 150 may inform the telecommunication system 133 that a membership service (merchant service) is available; and an operator may relay this message to the consumer's mobile device 111, telephone 112, and/or fax machine 113.

In one embodiment, the information servers 130 may communicate with the LM system 150 via a communication channel 140. The communication channel 140 may be implemented by an internal network such as an intranet. The communication channel 140 may also be secured by firewalls or encrypted, to ensure that the LM system 150 cannot be accessed without proper authorization.

In one embodiment, the LM system 150 may contain multiple functional modules, each of which may be implemented as a hardware/software functional component to perform a specific function for the LM system 150. As illustrated in FIG. 1, the LM system 150 may contain, without limitation, a membership management module 151, a consumer-vendor transaction module 152, a social-network & collaboration module 153, a notification and tracking module 154, a payment module 155, a CRM module 156, an ERP module 157, and a data analysis module 158.

In one embodiment, the membership management module 151 may store and manage membership accounts for the various consumers and merchants (e.g. brick-and-mortal retailers, online retainers, and various types of companies and businesses, etc), who provide and participate in the loyalty programs. In one embodiment, the consumer-vendor transaction module 152 may provide and control the membership usages and transactions. For example, the consumer-vendor transaction module 152 may allow membership services provided by the merchants to the clients 110, and track these membership services used by the clients 110.

In one embodiment, the social-network & collaboration module 153 may establish and manage a social-network among the consumers who are members of a common loyalty program or different loyalty programs. For example, a first member of a first loyalty program may interact with a second member of a second loyalty program for exchanging the membership services via a social network. In one embodiment, the notification and tracking module 154 may transmit loyalty alerts to the clients 110, and track the client devices' physical locations. A GPS auto tracking device may be attached with the clients 110 to automatically and constantly transmit location information to the notification and tracking module 154 without human intervention. The real-time positioning information may also be used for updating and adjusting the current or future membership services.

In one embodiment, a payment module 155 may manage the usage of funds that are deposited in the membership accounts. In one embodiment, a CRM module 156 may help the merchants to manage their individual membership programs. In one embodiment, an ERP module 157 may collect transactional information from all the other modules, and store the collected information as historical data for further analysis. The ERP module 157 may extract, clean, convert, and transplant the distributed data from difference sources into a central Data-Warehouse database. Afterward, a data analysis module 158 may perform Online Analytical Processing (OLAP) to further analyze and organize the data-warehouse-stored information, For example, data mining tolls may be deployed to identify useful information and extract business intelligence. The data analysis module 158 may also offer the business intelligence decision with visualization support, generate Key Performance Indicators, create a variety of illustrations trace analysis reports, industry reports and other statistical reports, and forecast enterprise performance appraisal for the leadership to provide integrated decision-making information.

In one embodiment, the LM system 150 may be implemented by one or more computer systems 160, each of which may include processors 161 and memory 162. The processor(s) 161 may include central processing units (CPUs) to control the overall operation of the system 160. In certain embodiments, the processor(s) 161 accomplish this by executing software or firmware stored in memory 162. The processor(s) 161 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 162 is or includes the main memory of the computer system 160. The memory 162 represents any form of random access memory (RAM), read-only memory (ROM), flash memory, or the like, or a combination of such devices. In use, the memory 162 may contain, among other things, a set of machine instructions which, when executed by processor 161, causing the processor 162 to perform operations to implement embodiments of the present disclosure.

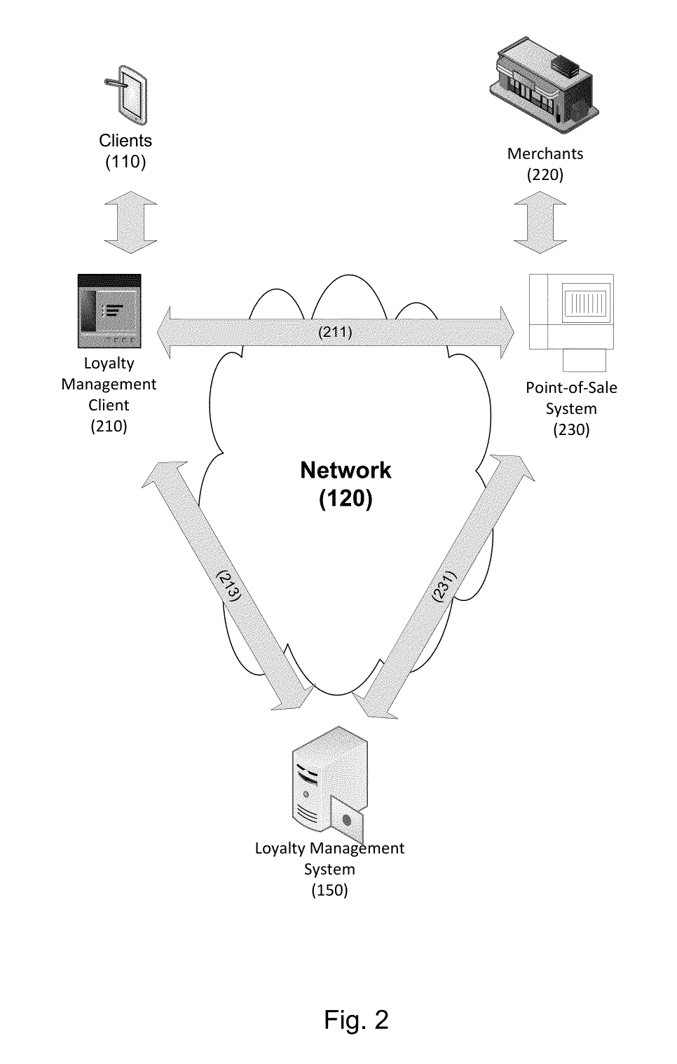

FIG. 2 illustrates exemplary interactions among multiple actors in a mobile loyalty management environment, according to certain embodiments of the present disclosure. A loyalty management client application (LM client) 210 may be installed on the clients 110. In one embodiment, the LM client 210 may be a smart-phone application developed for Google® Android®, Apple® iOS®, Nokia® Symbian®, Microsoft® Mobile®, etc. The clients 110 may be used by consumers who are conducting business transactions with merchants 220. The merchants 220 may have Point-of-Sale system (POS system) 230 for ordering, recording, and collecting fees during the business transactions. In one embodiment, the consumers may be members of a loyalty program provided by the merchants 220. During transaction 211, the LM client 220 may transmit membership information to the POS system 230 via a communication channel 211, so that the merchants 220 may be aware of the presence of the membership, and provide specific membership services to the consumers.

In one embodiment, a consumer may first access the LM system 150 via a communication channel 213 to establish a consumer account with the LM system 150. During consumer account creation, the consumer may provide “credential information”, such as, without limitation, account username, account passcode, full name, age, sex, address, phone number, social security number, employment and income information, credit card and bank accounts, preferences, and other personal information. Some or all of the credential information may be requested for by a merchant 220 in establishing a membership with a loyalty program of the merchant 220. Afterward, the LM client 210 may access the consumer account and the credential information stored in the LM system 150 via a secure consumer ID, which contains the consumer account username and passcode.

In one embodiment, a merchant 220 may access the LM system 150 via a communication channel 231 to establish a merchant account with the LM system 150. During merchant account creation, the merchant 220 may establish a specific loyalty program aimed for the consumers. The loyalty program membership may be applied using the “credential information” provided by the consumers. Alternatively, the merchant 220 may establish the loyalty program at the merchant's own computer environment or at the POS system 230. Afterward, the merchant 220 may access the merchant account in the LM system 150 to evaluate the memberships that enrolled in the loyalty program, analyze the transactions in utilizing the loyalty program, and determine the benefits and effects of the loyalty program. The merchant account may include a “program ID”, which can be used to uniquely locate and identify the specific loyalty program provided by the merchant.

In one embodiment, the consumer may be visiting or shopping at a physical store operated by a merchant 220. During shopping, the consumer may notice a membership program promoted by the merchant 220. For example, the membership program may be a frequent-shopping incentive program which provides discount and rebates to the members. The membership program may provide a “token” that is published and associated with the loyalty program. The token may be a phone number, a web address, or a unique symbol such as a barcode (one-dimensional or two-dimensional). For a mobile client 110 that has a camera, the consumer may use the camera to take an image of the token. Afterward, the LM client 210 may perform image recognition on the image, and detect a “program ID” from the token. For example, the web address in the token may be easily utilized to locate and identify the specific loyalty program's program ID. The barcode in the token may include the program ID.

In one embodiment, the LM client 210 may generate a secured consumer ID for identifying the consumer. Specifically, the LM client 210 on the mobile client 110 may determine device information associated with the mobile client 110. The “device information” may include, without limitation, the phone number of the mobile client 110, the unique device identifier such as International Mobile Equipment Identity (IMEI), and/or its network device physical address. In one embodiment, the secured consumer ID may further be generated to include the username and/or passcode of the consumer account that is established on the LM system 150. Thus, the secured consumer ID may be configured to uniquely identify the consumer, the mobile client 110, and/or the LM client 210.

In one embodiment, the LM client 210 may transmit a request to the LM system 150 via the communication channel 213. Specifically, the request, which may contain the secured consumer ID and/or the program ID of a loyalty program, may be used for signing-up the consumer to the loyalty program. Upon receiving the request from the LP client 210, the LM system 150 may retrieve the credential information associated with the consumer based on the secured consumer ID, and retrieve the loyalty program associated with the merchant 220 based on the program ID. Afterward, the LM system 150 may select the items in the credential information and utilize these items in creating a membership for the consumer in the loyalty program. In one embodiment, the specific items that can be used in creating the membership may be configured by the consumer in his consumer account. The merchant 220 may also configure its merchant account and the loyalty programs contained therein in establishing rules for accepting the new memberships. Upon a determination that the consumer is qualified for the membership based on the credential information, the LM system 150 may create the membership automatically. Thus, the consumer is freed from manually applying for the membership either via paper-and-pen, or via a web interface.

In one embodiment, once the consumer successfully signed-up with the loyalty program, the LM system 150 may provide one or more merchant services to the LM client 210. A “merchant service” may be a membership service offering discounts (e.g., coupons) that can be redeemed at the merchant, a frequent-buyer service that tracks a number of times the consumer has purchased goods and services from the merchant, a gift-card service which deducts purchase price from previously deposited amounts, and/or the combination thereof. The “merchant service” may be an announcement to inform the user of the LM client 210. Further, the “merchant service” may be an application program that can be loaded into and installed on the client 110. Afterward, the merchant service may be activated to interact with the LM system 150 or the POS system 230. The details of the merchant services are further described below.

In one embodiment, the consumer may already be a member of the merchant 220's loyalty program. In this case, the merchant 220 may already issue a physical membership card or a membership ID for the consumer. The LM client 210 may store the information related to the physical membership card or the membership ID for the consumer, so that in the future, the consumer may be able to redeem the benefits of the membership without having to carry and present the physical membership card or the membership ID. Specifically, the client 110 may use a camera to take an image of the physical membership card to store the detail information contained therein. Alternatively, the client 110 may have a card reading device attached to read the magnet strip of the membership card, in order to extract the detail card information contained therein. Afterward, the information and the physical appearance of the physical membership card may be stored in the LM client 210 for future usage. For example, the LM client 210 may generate a secured consumer ID based on the information obtained from the physical membership card or membership ID.

In one embodiment, upon signing-up with a loyalty program, the user interface of the LM client 210 may display an icon associated with the loyalty program. Thus, the icon may represent a membership of the loyalty program. Further, the LM client 210 may maintain multiple icons associated with multiple loyalty programs. When a user clicks on a first icon from the multiple icons, the LM client 210 may be configured to receive a selection the loyalty program that is associated with the first icon and identified by its program ID. The LM client 210 may then transmit a request to the LM system 150 seeking for one or more merchant services provided by the loyalty program. Specifically, the request may include, without limitation, a secured consumer ID and the program ID associated with the clicked icon. In one embodiment, the LM system 150 may generate the one or more merchant services based on the secured consumer ID and the program ID in the request. Alternatively, the LM system 150 may forward the request to the merchant 220 and/or the POS 230, both/either of which may generate the one or more merchant services for the LM client 210.

In one embodiment, the LM system 150 may generate a customized merchant service for a particular consumer user based on the secured credential information associated with the consumer. For example, a merchant service tailored to the consumer's age, sex, address, occupation, income may be generated to better target the consumer's tastes. Further, the LM system 150 may generate a second merchant service based on the consumer's actions with respect to a first merchant service he received. For example, upon a determination that the consumer redeemed multiple coupons for food items, additional merchant services that include food coupons may be generated for the specific consumer.

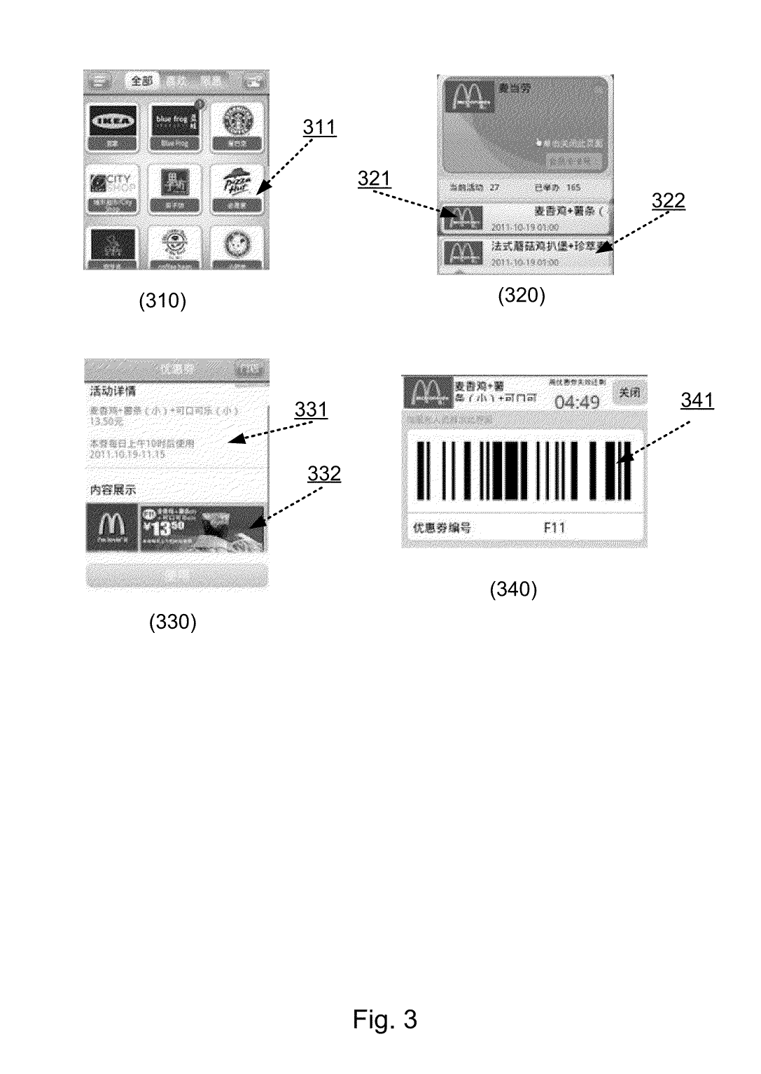

FIG. 3 illustrates multiple screen shots of a loyalty management client, according to some embodiments of the present disclosure. User interface 310 may show a loyalty management (LM) client 210 running on a mobile device having multiple icons 311, each of which representing a specific loyalty program the LM client 210 is registered with. A consumer user may click any one of the icons 311, resulting a user interface 320 being displayed by the LM client 210. During generating of the user interface 320, the LM client 210 may communicate with the LM system 150 and received one or more merchant services associated with the specific icon selected by the consumer user. For example, there are two merchant services 321 and 322 that are generated for the specific LM client 210, and downloaded from the LM system 150 to the LM client 210. The consumer user may further click on the merchant service 321, resulting a user interface 330 being displayed by the LM client 210.

In one embodiment, the merchant service 321 shown in the user interface 330 may be a redeemable coupon for a fast food meal. The detail section 331 may describe the context of the coupon as well as its valid period. When the consumer user clicks on the graphic element 332, the LM client 210 may receive a request for redeem the coupon. As a result, a user interface 340 may be displayed by the LM client 210. In user interface 340, a barcode 341 is displayed on the mobile client's screen. The consumer user may show the barcode to the merchant. A barcode scanner may be able to recognize the barcode 341, allowing the merchant to honor the merchant service 321 and the consumer to receive the benefits provided by the merchant service 321. In one embodiment, the barcode 341 is a graphic image supplied by the LM system 150 when generating the merchant service 321. Alternatively, the LM system 150 may provide a coupon number, and the LM client 210 may generate the barcode image 341 based on the coupon number.

Referring back to FIG. 2, in one embodiment, two mobile devices (a first mobile device and a second mobile device) may interact with each other based on a first merchant service received by the first mobile device. Specifically, when the LM client 210 of a first mobile device receives the first merchant service, it may transmit the first merchant service to a second mobile device, which may not have a version of LM client 210 installed, or may not sign up with the loyalty program. In this case, the consumer user of the second mobile device may nevertheless desire to receive the first merchant service that is available on the first mobile device. Thus, the LM client 210 of the first mobile device may transmit the first merchant service as a package to the second mobile device. For example, the package may be a text message, an email, or a network package utilizing the network communication capabilities of the two mobile devices.

In one embodiment, upon receiving the first merchant service, the second mobile device may detect its own device information, and transmit the received first merchant service and the detected device information to the LM system 150. The LM system 150 may then try to automatically sign-up the second mobile device to a membership with the loyalty program based on the first merchant service and the device information of the second mobile device. Thus, the merchant 220 may use an attractive merchant service to encourage non-member consumers to sign-up to the loyalty program via a member consumer.

In one embodiment, the consumer user may own both the first mobile device and the second mobile device. In this case, the second mobile device may further transmit a consumer account username and passcode, along with the device information and the merchant service, to the LM system 150. The LM system 150 may use the username and passcode to retrieve the consumer account, and signup the second mobile device to the memberships which the consumer already belongs to. Afterward, the second mobile device may be associated with the loyalty program as the first mobile device.

In another embodiment, the second mobile device may be owned by a non-member consumer. In this case, the LM system 150 may not have the credential information of the non-member consumer, and therefore cannot sign-up the non-member consumer to the loyalty program as illustrated above. Still, the LM system 150 may sign-up the second mobile device to a temporary or low-privileged membership, so that the non-member consumer may at least use the first merchant service received from the first mobile device. Further, the non-member consumer may receive some limited merchant services from the LM system 150 to try out the loyalty program before applying for full membership. In other words, the LM system 150 may further transmit additional merchant services using conventional data communication approaches (e.g., SMS, email, web page links, etc) to the second mobile device, even though the second mobile device does not have a LM client 210 installed.

In one embodiment, the LM system 150 may broadcast a request invitation to multiple mobile devices. The broadcasting may be implemented either using short distance wireless communication approaches (e.g., WIFI, Bluetooth®, etc), or long distance communication approaches (e.g., via the Internet). The “request invitation” may include a program ID associated with a specific loyalty program that is seeking additional memberships, and may be in a form such as SMS, email, web link, and/or messages delivered by a wireless communication signal. The request invitation may also be related to a specific merchant service associated with a loyalty program. In this case, the request invitation may seek consumers who are already members of the loyalty program to participate in a promotional activity, such as receiving a group coupon.

When a mobile device receives the request invitation, it may generate the secured consumer ID based on the request invitation, the mobile device's device information of, and a passcode supplied by the consumer. Afterward, the mobile device may transmit the secured consumer ID to the LM system 150 for signing-up or logging in the loyalty program identified in the request invitation. For example, the LM system 150 may provide location-based invitation by targeting the delivery of the request invitation to a specific group of consumers at a specific location. Thus, only the consumers who are present at the specific location may receive the request invitation, and thereby have a chance to join the loyalty program or participate in a promotion.

In one embodiment, a POS system 230 may also broadcast a request invitation as described above. For example, the POS system 230 may invite the consumers who come to the merchant's store to join a loyalty program. Further, the LM system 150 and the POS system 230 may configure a restriction to be included in the request invitation. A “restriction” may put certain limitation on joining the loyalty program or participate in a promotion activity. Specifically, a restriction may be time-based, location-based, number-based, and/or type-based. For example, a time-based restriction may limit (include or exclude) the joining of the loyalty program to a certain time period. A location-based restriction may require a mobile device to provide its GPS reading, in order to determine whether the mobile device is positioned within the proximity of a permitted area. Further, a number-based restriction may limit the number of consumers that can join the membership. Alternatively, a number-based restriction may require a certain amount of people to participate before the promoted merchant service becomes active. A type-based restriction may limit the participation based on certain data types (e.g., mobile device type, membership type, purchased good type, etc).

In one embodiment, upon receiving a request invitation from the POS system 230 (or the LM system 150), a mobile device (as well as its LM client 210) may transmit a response to the POS system 230. The response may be an acceptance of the request invitation, and may contain a status. The “status” may provide the time, location, and/or number that are requested by the request invitation's restriction. Upon a determination that the status satisfies the restriction, the POS system 230 may allow the joining of the loyalty program or utilizing of a merchant service. Otherwise, the response may be ignored or postponed for processing. Further, a merchant service may be transmitted to the mobile devices which provided responses having a satisfactory status. For example, a group coupon may be activated once there are more than 10 consumers signing-up. In this case, a request invitation having a restriction of “more than 10 members” may be sent to the mobile devices belonging to the potential consumers. After the POS system 230 receives responses from 10 mobile devices, the 11^{th} response it received may contain a status indicating it being the 11^{th} accepting member. Thus, the status of the 11^{th} member may satisfy the restriction in the request invitation, and the POS system 230 may transmit a merchant service for a group coupon to one or more of the mobile devices which responded to the request invitation.

In one embodiment, when a LM client 210 determines to utilize a merchant service it received, the LM client 210 may generate a consumption message indicating the LM client 210's desire to utilize the merchant service. The “consumption message” may be a part of an action such as activating and showing a coupon, or deducting points from the consumer account. Upon receiving the consumption message, the POS system 230 may either approve or disapprove the utilization of the merchant service. For example, the POS system 230 may determine that the merchant service, which may be a coupon, may already be expired.

In one embodiment, the LM client 210 may also transmit consumption message, as well as a secured consumer ID or a membership ID, to the POS system 230 for utilizing a merchant service. Based on the received consumption message and the membership ID, the POS system 230 may generate a receipt indicating the utilization of the merchant service by the mobile device and its LM client 210. The receipt may be transmitted to the LM system 150 for processing. For example, the LM system 150 may extract the secured consumer ID and the consumption message from the receipt. The LM system 150 may further extract the merchant transaction information from the receipt. The transaction information, such as the purchased items and their prices, the total prices, etc, may be input into the consumer account and the merchant account. Thus, the transaction information may be used to accumulate points, and/or generate additional discounts, for the consumer.

In one embodiment, the LM system 150 may generate a second merchant service based on the first merchant service, as well as a consumption message associated with the first merchant service. The second merchant service may then be transmitted subsequent to the delivery of the first merchant service to the mobile device. For example, during a purchase transaction in which a consumer is redeeming a first coupon, upon a determination that the first coupon is activated during a promotional period, the POS system 230 may delivery a second coupon (for additional saving on the top of the first coupon) to the mobile device, allowing the consumer to receive further savings before complete the purchase transaction.

In one embodiment, the POS system 230 may receive the consumption message by utilizing an input device connected with the POS system 230. The input device may be a camera or a scanning device that can detect an image being displayed on a screen of a mobile device. The image may be a barcode, a text string, or a picture presented by the LM client 210. By performing image recognition or code-scanning, the POS system 230 may detect the consumption message shown by the mobile device.

In one embodiment, the LM system 150 may present a first merchant service to a consumer which the POS system 230 may not be aware of. In this case, the LM system 150 may send a second merchant service to the POS system 230 concurrently as the sending of the first merchant service to the LM client 210. To utilize the first merchant service, the LM client 210 may first deliver a consumption message to the POS system 230. Upon receiving the consumption message, the POS system 230 may activate the second merchant service it received, and inputting the consumption message to the second merchant service for validation. Upon proper validation, the POS system 230 may allow the utilization of the first merchant service, and provide benefits to the consumer. Such an approach may ensure that the merchant services may be simultaneously and dynamically delivered to the consumer and POS system 230 without prior preparation.

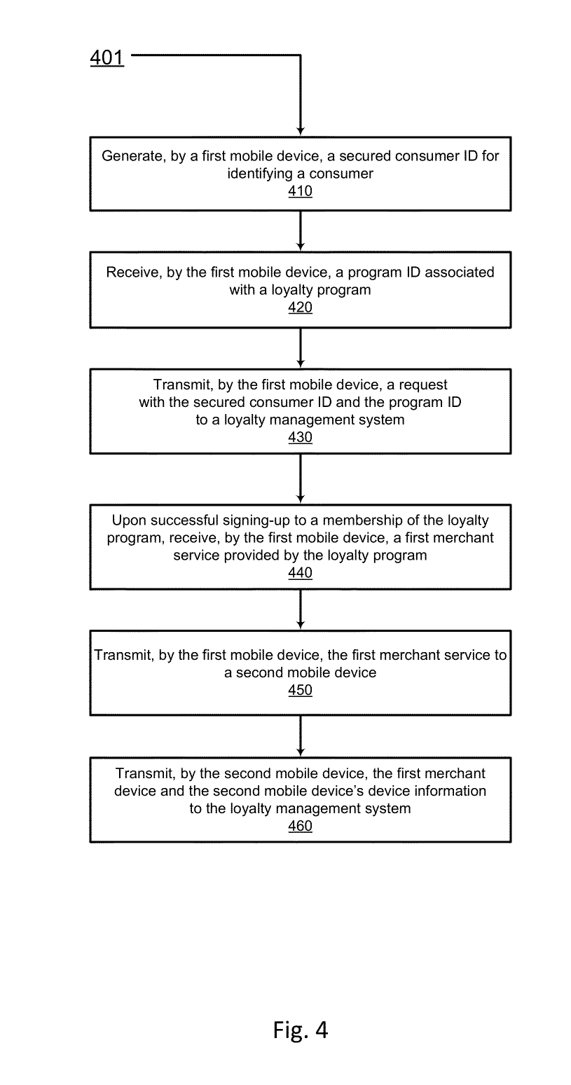

FIG. 4 shows a flow diagram illustrating one example process 401 for signing-up and utilizing a loyalty program, according to some embodiments of the present disclosure. The process 401 sets forth various functional blocks or actions that may be described as processing steps, functional operations, events, and/or acts, which may be performed by hardware, software, and/or firmware. Those skilled in the art in light of the present disclosure will recognize that numerous alternatives to the functional blocks shown in FIG. 4 may be practiced in various implementations.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

At block 410, a first mobile device and/or its associated LM client may generate a secured consumer ID for identifying a consumer. In one embodiment, the first mobile device may determine a device information associated with the first mobile device, and generate the secured consumer ID based on the device information and a passcode supplied by the consumer. In another embodiment, the first mobile device may receive a card information associated with a physical card. The first mobile device may generate the secured consumer ID based on the card information and a passcode supplied by the consumer.

At block 420, the first mobile device may receive a program ID associated with the loyalty program. In one embodiment, the first mobile device may take an image of a token associated with the loyalty program, utilizing a camera coupled with the first mobile device to. The first mobile device may detect the program ID from the image by performing an image recognition on the image.

At block 430, the first mobile device may transmit a request with the secured consumer ID and the program ID to a loyalty management system for signing up the consumer and the mobile device to the loyalty program. Upon receiving the request, he loyalty management system may retrieve credential information associated with the consumer based on the secured consumer ID, and uses the credential information to automatically sign-up the consumer to a membership with the loyalty program identified by the program ID.

At block 440, upon successful signing-up to a membership of the loyalty program, the first mobile device may receive from the loyalty management system, a first merchant service provided by the loyalty program. The first mobile device may utilize the merchant service by redeeming via a POS system provided by a merchant.

At block 450, the first mobile device may help distributing the first merchant device by transmitting the first merchant service to a second mobile device, which is not associated with any membership of the loyalty program. At block 460, the second mobile device may try to participate in the loyalty program by transmitting the first merchant service and a device information of the second mobile device to the loyalty management system. Upon receiving the above information, the loyalty management system may automatically sign-up the second mobile device to a membership (e.g., a temporary membership) with the loyalty program based on the first merchant service.

In one embodiment, the second mobile device may simply transmit its device information and/or the first merchant service to the loyalty management system without signing-up to a membership of the loyalty program. In this case, the loyalty management system may nevertheless determine a second merchant service for the second mobile device and provided by the loyalty program based on the device information of the second mobile device and/or the first merchant service.

In one embodiment, the first mobile device may maintain a plurality of memberships associated with a plurality of loyalty programs. The first mobile device may receive a selection, originated by a consumer user, of a specific membership from the plurality of memberships. The first mobile device may then transmit a request with the secured consumer ID and the program ID associated with the specific membership to the loyalty management system, and receive a specific merchant service for the consumer and provided by the loyalty management system, based on the secured consumer ID and the first membership's associated loyalty program. Thus, the first mobile device allows a consumer user to take advantage of the benefits provided by the specific membership.

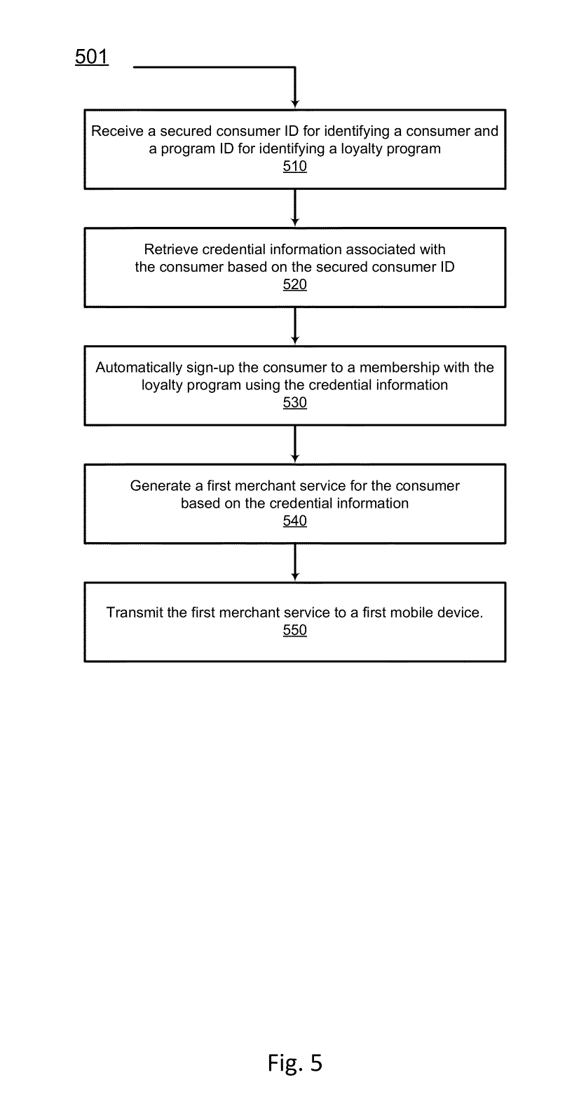

FIG. 5 shows a flow diagram illustrating one example process 501 for providing automatic signing-up services by a loyalty management system and providing associated merchant services, according to some embodiments of the present disclosure. The process 501 sets forth various functional blocks or actions that may be described as processing steps, functional operations, events, and/or acts, which may be performed by hardware, software, and/or firmware. Those skilled in the art in light of the present disclosure will recognize that numerous alternatives to the functional blocks shown in FIG. 5 may be practiced in various implementations.

At block 510, a loyalty management system (LM system) may receive from a first mobile device a secured consumer ID for identifying the consumer and a program ID for identifying the loyalty program. In one embodiment, the LM system may first broadcast a request invitation including the program ID to a plurality of mobile devices. The first mobile device may receive the request invitation and generate the secured consumer ID based on the request invitation. The secured consumer ID may further include the first mobile device's device information and/or a passcode supplied by the consumer.

At block 520, the LM system may retrieve credential information associated with the consumer based on the secured consumer ID. The credential information may be previously maintained by the LM system. At block 530, upon a determination that the consumer is not signed-up with the loyalty program identified by the program ID, the LM system may automatically sign-up the consumer to a membership with the loyalty program using the credential information associated with the consumer.

At block 540, the LM system may generate a first merchant service for the consumer based on the credential information. The first merchant service may be provided by the loyalty program identified by the program ID. At block 550, the LM system may transmit the first merchant service to the first mobile device.

In one embodiment, the LM system may transmit a plurality of memberships to the first mobile device based on the secured consumer ID, once the consumer has signed-up with each of the plurality of memberships. In another embodiment, the LM system may receive the first merchant service, which has previously transmitted to the first mobile device, from the first mobile device, and generate a second merchant service for the first mobile device (as well as the consumer) based on the credential information and the first merchant service. Afterward, the LM system may transmit the second merchant service to the first mobile device. The second merchant service may allow the first mobile device to receive additional services based on the utilization of the first merchant service.

In one embodiment, the LM system may receive, from a second mobile device, the first merchant service and a device information of the second mobile device. Upon a determination that the device information is not associated with the loyalty program, (meaning the consumer or the second mobile device has not been signed-up with the loyalty program), the LM system may automatically sign-up the second mobile device to a temporary membership with the loyalty program based on the device information and the first merchant service. Afterward, the LM system may generate a second merchant service for the second mobile device based on the temporary membership and the first merchant service, and transmit the second merchant service to the second mobile device.

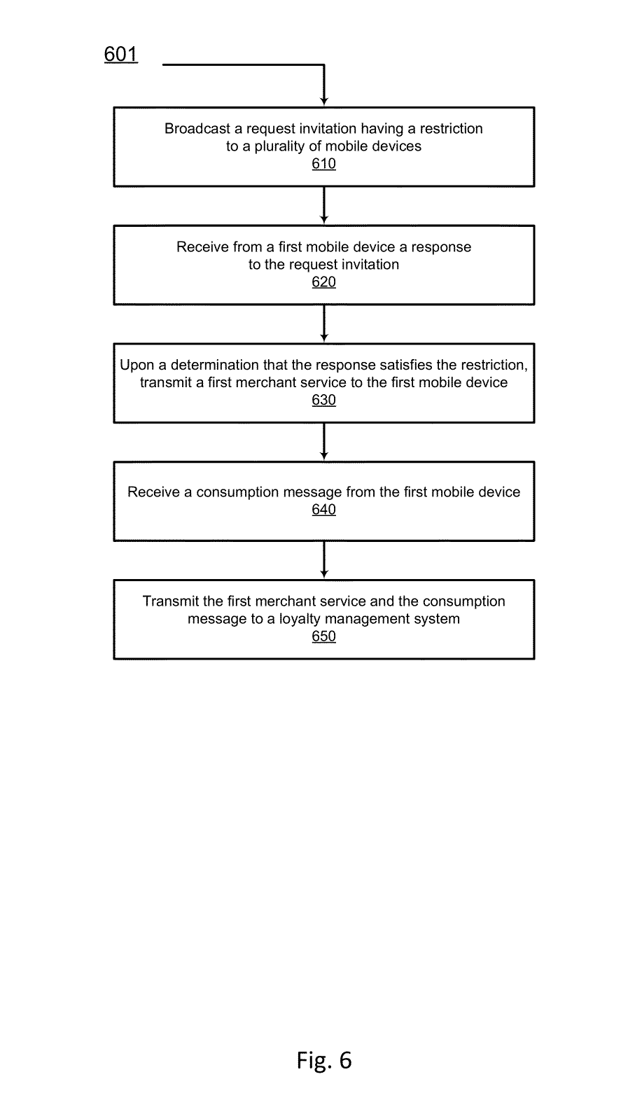

FIG. 6 shows a flow diagram illustrating one example process 601 for interacting with mobile devices by a point-of-sale system, according to some embodiments of the present disclosure. The process 601 sets forth various functional blocks or actions that may be described as processing steps, functional operations, events, and/or acts, which may be performed by hardware, software, and/or firmware. Those skilled in the art in light of the present disclosure will recognize that numerous alternatives to the functional blocks shown in FIG. 6 may be practiced in various implementations.

At block 610, a point-of-sale system (POS system) may broadcast a request invitation having a restriction to a plurality of mobile devices. In one embodiment, the restriction in the request invitation is related to the loyalty program, and may be one or more of a time restriction, a location restriction, a number restriction, and a type restriction.

At block 620, the POS system may receive, from a first mobile device of the plurality of mobile devices, a response to the request invitation. The response may contain a status related to the first mobile device. At block 630, upon a determination that the status satisfies the restriction, the POS system may transmit a first merchant service to the first mobile device. At block 640, the POS system may receive a consumption message from the first mobile device indicating the utilization of the first merchant service by the first mobile device.

In one embodiment, the POS system may receive the consumption message by detecting an image displayed on a screen of the first mobile device, utilizing an input device coupled with the POS system. The POS system may detect the utilization message from the image by performing an image recognition on the image.

In one embodiment, in addition to the consumption message, the POS system may receive, from the first mobile device, a secured consumer ID for identifying the consumer. The POS system may generate a receipt indicating the secured consumer ID and the consumption message. A loyalty management system (LM system), which may be configured to process the receipt, may receive the receipt, extract the secured consumer ID and the consumption message from the receipt, and update a membership utilization information associated with the consumer.

At block 650, the POS system may transmit the first merchant service and the consumption message to the LM system. In one embodiment, the POS system may receive a second merchant service from the LM system based on the first merchant service and the consumption message. The POS system may then transmit the second merchant service to the first mobile device.

In one embodiment, the POS system may receive, from the LM system, a second merchant service associated with the first merchant service. In this case, the consumption message provided by the first mobile device may be evaluated based on the second merchant service before it can be allowed for utilization. Upon a determination that the consumption message is acceptable for the second merchant service, the POS system may then allow the utilization of the first merchant service by the first mobile device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities.

Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or a firmware configuration; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), ARM Processors, CPUs or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of the skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory storage medium used to actually carry out the distribution. Examples of a non-transitory storage medium include, but are not limited to, the following: a recordable type medium such as a floppy disk, a hard disk drive, a Compact Disc (CD), a Digital Video Disk (DVD), a digital tape, a computer memory, Flash Memory, etc.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

I claim:

1. A method for signing up a consumer with a loyalty program, comprising:
generating, by a first mobile device, a secured consumer ID for identifying the consumer;
receiving, by the first mobile device, a program ID associated with the loyalty program;
transmitting, by the first mobile device, a request with the secured consumer ID and the program ID to a loyalty management system for signing up to the loyalty program, wherein the loyalty management system retrieves credential information associated with the consumer based on the secured consumer ID, and uses the credential information to automatically sign-up the consumer to the loyalty program identified by the program ID; and
upon successful signing-up to a membership of the loyalty program, receiving, by the first mobile device from the loyalty management system, a first merchant service provided by the loyalty program.

2. The method as recited in claim 1, wherein the generating of the secured consumer ID comprises:
determining, by the first mobile device, a device information associated with the first mobile device; and
generating, by the first mobile device, the secured consumer ID based on the device information and a passcode supplied by the consumer.

3. The method as recited in claim 1, wherein the generating of the secured consumer ID comprises:
receiving, by the first mobile device, a card information associated with a physical card; and
generating, by the first mobile device, the secured consumer ID based on the card information and a passcode supplied by the consumer.

4. The method as recited in claim 1, wherein the receiving of the program ID comprises:
taking an image of a token associated with the loyalty program by utilizing a camera coupled with the first mobile device; and
detecting the program ID from the image by performing an image recognition on the image.

5. The method as recited in claim 1, further comprising:
transmitting, by the first mobile device, the first merchant service to a second mobile device, wherein the second mobile device is not associated with the loyalty program.

6. The method as recited in claim 5, further comprising:
transmitting, by the second mobile device, the first merchant service and a device information of the second mobile device to the loyalty management system, wherein the loyalty management system automatically signs-up the second mobile device to another membership of the loyalty program based on the first merchant service.

7. The method as recited in claim 6, further comprising:
transmitting, by the second mobile device, the device information of the second mobile device to the loyalty management system, wherein the loyalty management system determines a second merchant service provided by the loyalty program based on the device information of the second mobile device.

8. The method as recited in claim 1, further comprising:
maintaining, by the first mobile device, a plurality of memberships associated with a plurality of loyalty programs;
receiving, by the first mobile device, a selection of a first membership from the plurality of memberships;
transmitting, by the first mobile device, a request with the secured consumer ID and the first membership to the loyalty management system; and
receiving, by the first mobile device, a second merchant service for the consumer provided by the loyalty management system based on the secured consumer ID and the first membership's associated loyalty program.

9. A method for serving a consumer utilizing a loyalty program, comprising:
receiving, by a loyalty management system from a first mobile device, a secured consumer ID for identifying the consumer and a program ID for identifying the loyalty program;
retrieving, by the loyalty management system, credential information associated with the consumer based on the secured consumer ID;
generating, by the loyalty management system, a first merchant service for the consumer based on the credential information, wherein the first merchant service is provided by the loyalty program identified by the program ID; and
transmitting, by the loyalty management system, the first merchant service to the first mobile device.

10. The method as recited in claim 9, further comprising:
transmitting, by the loyalty management system, a plurality of memberships to the first mobile device based on the secured consumer ID, wherein the consumer has signed-up with the plurality of memberships.

11. The method as recited in claim 9, further comprising:
upon a determination that the consumer is not signed-up with the loyalty program identified by the program ID, automatically signing-up, by the loyalty management system, the consumer to a membership with the loyalty program using the credential information associated with the consumer.

12. The method as recited in claim 9, further comprising:
broadcasting, by the loyalty management system, a request invitation including the program ID, wherein the first mobile device receives the request invitation and generates the secured consumer ID based on the request invitation, the first mobile device's device information, and a passcode supplied by the consumer.

13. The method as recited in claim 9, further comprising:
receiving, by the loyalty management system, the first merchant service from the first mobile device;
generating, by the loyalty management system, a second merchant service for the first mobile device based on the credential information and the first merchant service; and
transmitting, by the loyalty management system, the second merchant service to the first mobile device.

14. The method as recited in claim 9, further comprising:
receiving, by the loyalty management system from a second mobile device, the first merchant service and a device information of the second mobile device;
upon a determination that the device information is not associated with the loyalty program, automatically signing-up, by the loyalty management system, the second mobile device to a temporary membership with the loyalty program based on the device information and the first merchant service;
generating, by the loyalty management system, a second merchant service for the second mobile device based on the temporary membership and the first merchant service; and
transmitting, by the loyalty management system, the second merchant service to the second mobile device.

15. A method for accepting a merchant service supplied by a consumer, comprising:
broadcasting, by a point-of-sale system, a request invitation having a restriction to a plurality of mobile devices;
receiving, by the point-of-sale system from a first mobile device of the plurality of mobile devices, a response to the request invitation, wherein the response contains a status;
upon a determination that the status satisfies the restriction, transmitting, by the point-of-sale system, a first merchant service to the first mobile device; and
receiving, by the point-of-sale system, a consumption message from the first mobile device indicating the utilization of the first merchant service by the first mobile device.

16. The method as recited in claim 15, further comprising:
receiving, by the point-of-sale system from the first mobile device, a secured consumer ID for identifying the consumer; and
generating, by the point-of-sale system, a receipt indicating the secured consumer ID and the consumption message, wherein a loyalty management system is configured to process the receipt, extract the secured consumer ID and the consumption message from the receipt, and update a membership utilization information associated with the consumer.

17. The method as recited in claim 15, further comprising:
transmitting, by the point-of-sale system, the first merchant service and the consumption message to a loyalty management system;
receiving, by the point-of-sale system, a second merchant service based on the first merchant service and the consumption message; and
transmitting, by the point-of-sale system, the second merchant service to the first mobile device.

18. The method as recited in claim 15, further comprising:
receiving, by the point-of-sale system from a loyalty management system, a second merchant service associated with the first merchant service; and
upon a determination that the consumption message is acceptable for the second merchant service, allowing the utilization of the first merchant service by the first mobile device.

19. The method as recited in claim 15, wherein the restriction in the request invitation is related to the loyalty program, and is one or more of a time restriction, a location restriction, a number restriction, and a type restriction.

20. The method as recited in claim 15, wherein the receiving of the utilization message from the first mobile device comprises:
detecting an image displayed on a screen of the first mobile device by utilizing an input device coupled with the point-of-sale system; and
detecting the utilization message from the image by performing an image recognition on the image.
